(19) United States
(12) Patent Application Publication
(10) Pub. No.: US 2026/0361863 A1
(43) Pub. Date: Nov. 12, 2026

(54) HARDWARE FRIENDLY DESIGN FOR SEMI DECOUPLED PARTITION SCHEME

(71) Applicant: Tencent America LLC, Palo Alto, CA (US)

(72) Inventors: Jayasingam ADHURAN, Palo Alto, CA (US); Liang ZHAO, Palo Alto, CA (US); Madhu PERINGASSERY KRISHNAN, Palo Alto, CA (US); Tianqi LIU, Palo Alto, CA (US); Shan LIU, Palo Alto, CA (US)

(21) Appl. No.: 19/366,473

(22) Filed: Oct. 22, 2025

Related U.S. Application Data
(60) Provisional application No. 63/801,787, filed on May 7, 2025.

(51) Int. Cl. H04N 19/119; H04N 19/176; H04N 19/186

(52) U.S. Cl. CPC H04N 19/119; H04N 19/176; H04N 19/186

(57) ABSTRACT

An example method includes receiving a video bitstream comprising a plurality of blocks, including a superblock containing multiple blocks encoded using a local intra block copy mode. The method includes identifying an initial reference region for the superblock based on a coded region and a size of a reference buffer. The method includes reconstructing a first block of the superblock using the initial reference region. The method includes identifying an updated reference region by updating the initial reference region based on a location of a second block of the superblock. The method also includes reconstructing the second block using the updated reference region.

### RELATED APPLICATIONS

This application claims priority to U.S. Provisional Patent Application No. 63/801,787, entitled “Hardware Friendly Design for Semi Decoupled Partition Scheme,” filed May 7, 2025, which is hereby incorporated by reference in its entirety.

### TECHNICAL FIELD

The disclosed embodiments relate generally to video coding, including but not limited to systems and methods for block partitioning.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On January 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates.

### SUMMARY

The present disclosure describes amongst other things, a set of methods for video (image) compression, more specifically related to simplifying how decoupling of a chroma partitioning of a current block from a luma partitioning of the current block is determined for semi-decoupled partitioning (SDP). By simplifying how the decoupling is determined, decoding time and hardware requirements may be reduced by not having to recursively check through all child partitions of a luma block to determine if any of the resulting partition is less than a size threshold in order for the chroma block to inherit the partitioning of the luma block. Advantages of the simplified determination include the removal of parsing dependency of the chroma block that is based on the block size of the luma partitions, and faster decoding time may be achieved by checking only a fixed depth of partitions (e.g., up to 2) during the determination process. In other words, the determination of the chroma partition, while still dependent on the luma partitions, is not dependent on the luma block sizes of the partitions.

In accordance with some embodiments, a method of video decoding includes (i) receiving a video bitstream (e.g., a coded video sequence) comprising a plurality of blocks including a chroma block and a co-located luma block; (ii) partitioning the chroma block according to partitioning of the co-located luma block until a first partition point; and (iii) when the co-located luma block is partitioned using an uneven-4-way partition at the first partition point, partitioning the chroma block beyond the first partition point using a partition other than the uneven-4-way partition.

In accordance with some embodiments, a method of video encoding includes (i) receiving video data (e.g., a source video sequence) comprising a plurality of blocks, including a chroma block and a co-located luma block; (ii) partitioning the chroma block according to partitioning of the co-located luma block until a first partition point; and (iii) when the co-located luma block is partitioned using an uneven-4-way partition at the first partition point, partitioning the chroma block beyond the first partition point using a partition other than the uneven-4-way partition.

In accordance with some embodiments, a method of video media bitstream generation includes: (i) generating a video bitstream, including: (a) partitioning the chroma block according to partitioning of the co-located luma block until a first partition point; and (b) when the co-located luma block is partitioned using an uneven-4-way partition at the first partition point, partitioning the chroma block beyond the first partition point using a partition other than the uneven-4-way partition; and (ii) transmitting the video bitstream including the encoded current block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder). In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding. The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIGS. 4A, 4B, 4C, 4D, 4E-1-4E-4 illustrate examples of partitioning of coding blocks in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including simplifying how decoupling of a chroma partitioning of a current block from a luma partitioning of the current block is determined for semi-decoupled partitioning (SDP). By simplifying how the decoupling is determined, decoding time and hardware requirements may be reduced by not having to recursively check through all child partitions of a luma block to determine if any of the resulting partition is less than a size threshold in order for the chroma block to inherit the partitioning of the luma block. Advantages of the simplified determination include the removal of parsing dependency of the chroma block that is based on the block size of the luma partitions, and faster decoding time may be achieved by checking only a fixed depth of partitions (e.g., up to 2) during the determination process. In other words, the determination of the chroma partition, while still dependent on the luma partitions, is not dependent on the luma block sizes of the partitions.

The implementations described herein provide a simplified approach for determining how chroma block partitioning is related to luma block partitioning in video coding, specifically for semi-decoupled partitioning schemes. Traditionally, deciding whether chroma should follow luma partitioning required recursively checking all child partitions of the luma block to see if any resulting partition was below a certain size threshold. This process was complex and posed challenges for hardware implementation. The implementations described herein replace this recursive search with a logic that relies only on the types and directions of luma partitions at a fixed depth (e.g., up to two levels) from a key partition point, such as the 64×64 block size. For example, if the luma block is split using an uneven-4-way partition at this point, the chroma block is partitioned independently. If the luma block is split in other ways, the chroma block may inherit the luma partitioning, depending on the directionality of the child partitions. This approach eliminates the need for chroma partitioning to depend on the sizes of luma partitions, focusing instead on partition types and directions. As a result, the determination process is simpler and more hardware-friendly, requiring only a limited number of checks. The associated benefits include: (1) reduced hardware complexity and lower resource requirements, since the process avoids deep recursive searches; (2) faster decoding and encoding times, as only a fixed number of partition levels are checked; (3) improved coding efficiency, as chroma can be decoupled from luma when appropriate, without sacrificing compression performance; and (4) enhanced scalability and ease of implementation in hardware, which makes it more suitable for real-time and resource-constrained environments.

### Example Systems and Devices

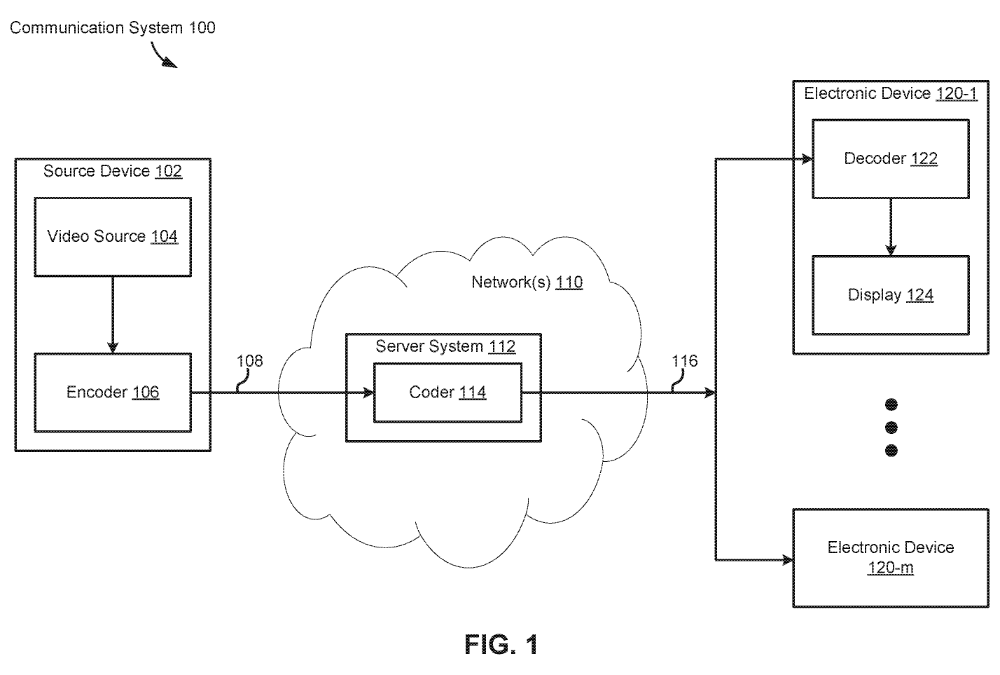

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

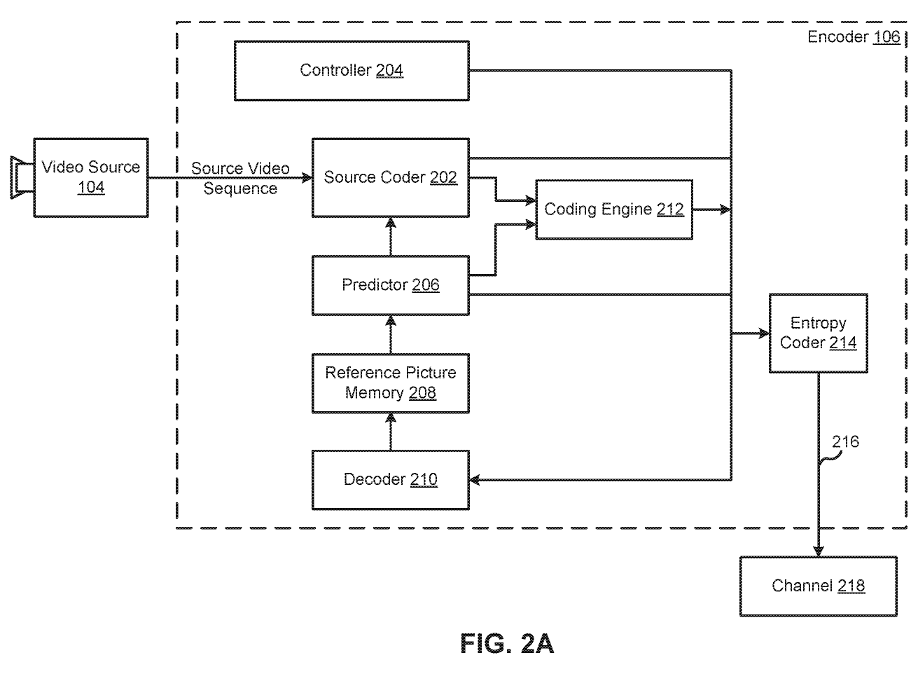

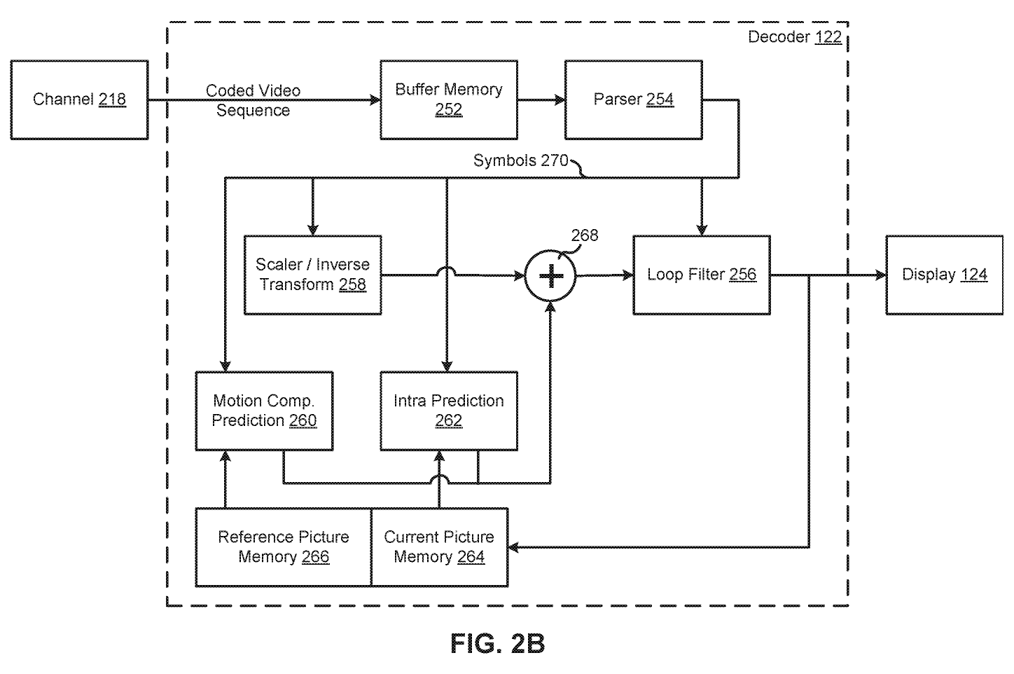

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks’ respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

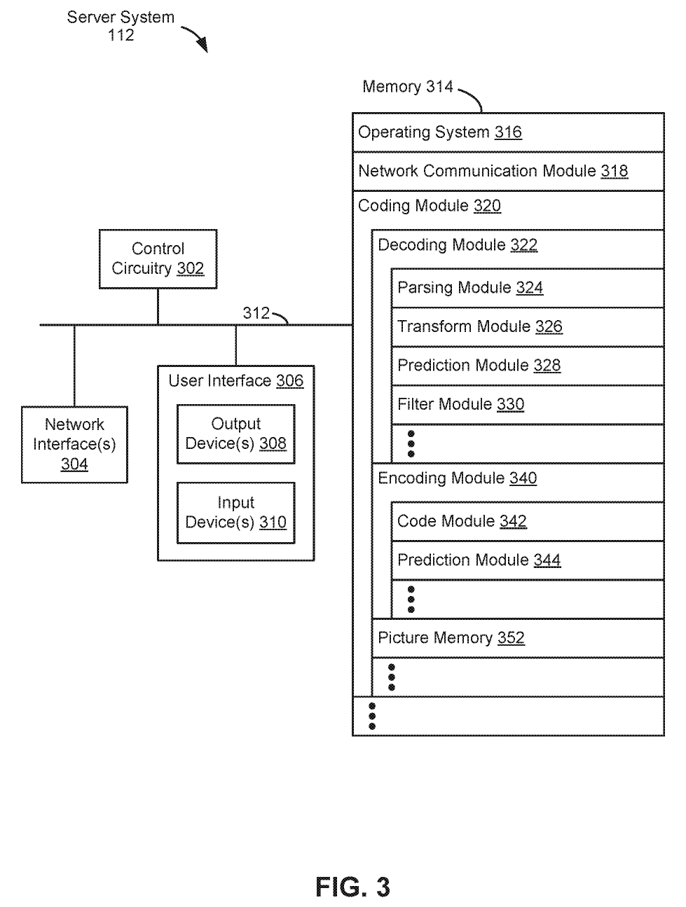

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). The present disclosure describes simplifying how decoupling of a chroma partitioning of a current block from a luma partitioning of the current block may be determined for SDP.

As used herein, the term “block” may refer to a coding block (such as super block, or largest coding unit, or coding tree block), a prediction block, a transform block, or a filtering unit. Additionally, a “subblock” of a block A refers to a block whose area is fully contained in the block A. Block shape can be referred to as a block width to height ratio, block area size, whether a block is a square block, a tall block or a flat block, and the like.

As used herein, the term “partitioning” may refer to splitting one coding block into a single or multiple smaller blocks. As described previously, general partitioning may start from a base block (e.g., a superblock or root node) and may follow a predefined ruleset, partition structure, and/or scheme. The partitioning may be hierarchical and/or recursive. After dividing or partitioning a base block using any of the example partitioning procedures or other procedures described herein, or the combination thereof, a final set of partitions or coding blocks may be obtained. Each of these partitions may be at one of various partitioning levels in the partitioning hierarchy, and may be of various shapes. Each of the partitions may be referred to as a coding block (CB), such partitions are referred to as coding blocks because they may form units for which some basic coding/decoding decisions may be made and coding/decoding parameters may be optimized, determined, and signaled in an encoded video bitstream. The highest or deepest level in the final partitions represents the depth of the coding block partitioning structure of tree. A coding block may be a luma coding block or a chroma coding block. The hierarchical structure of for all color channels may be collectively referred to as coding tree unit (CTU). The partitioning patterns or structures for the various color channels in a CTU may or may not be the same.

A region, or coding region, may be used to refer to any level in any one of the partitioning schemes described above or in other partitioning schemes not specifically described above. A region therefore may be a frame, a slice, a super block, a macroblock, a subblock, a prediction block, and the like. For example, a region may be any partitioning level of a recursive partitioning scheme.

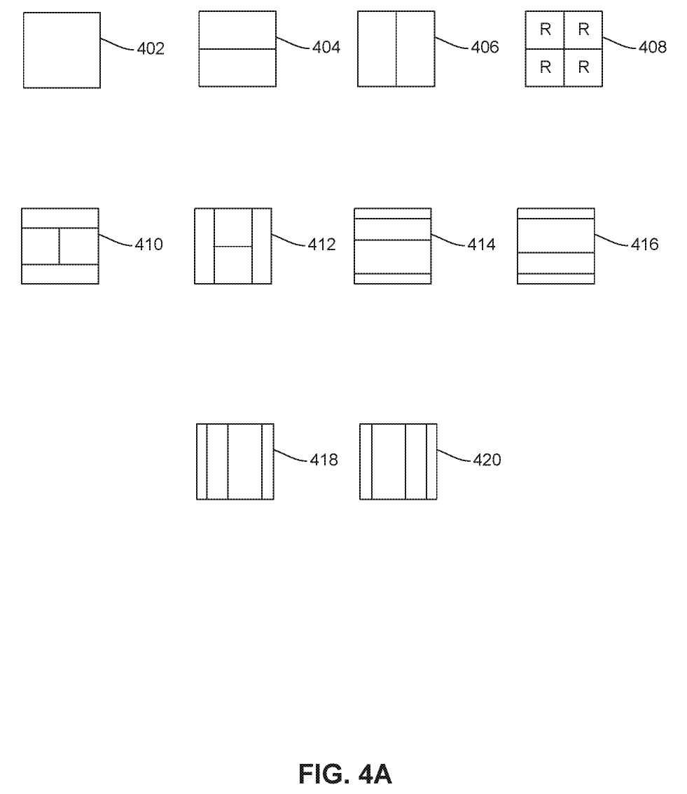

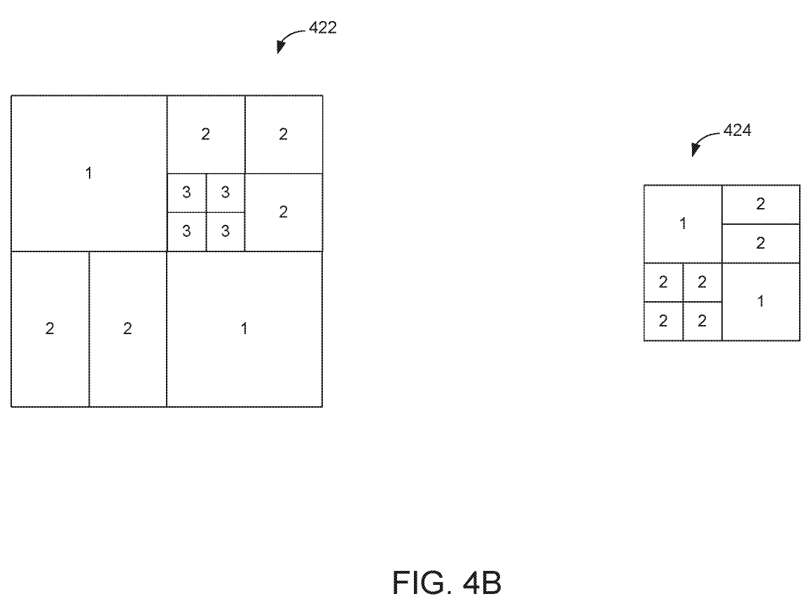

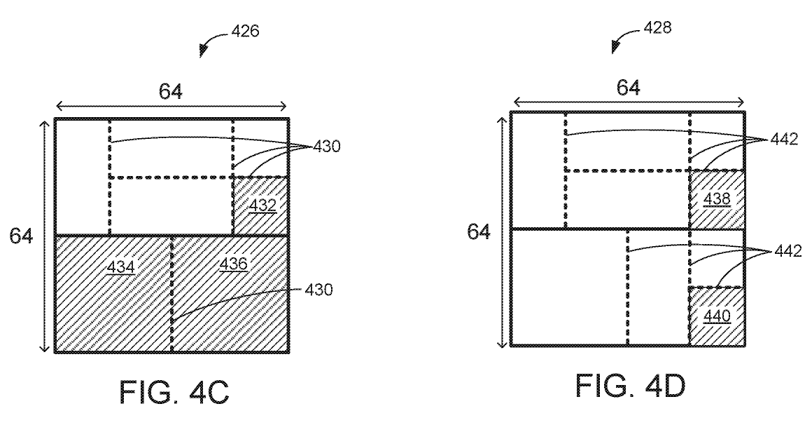

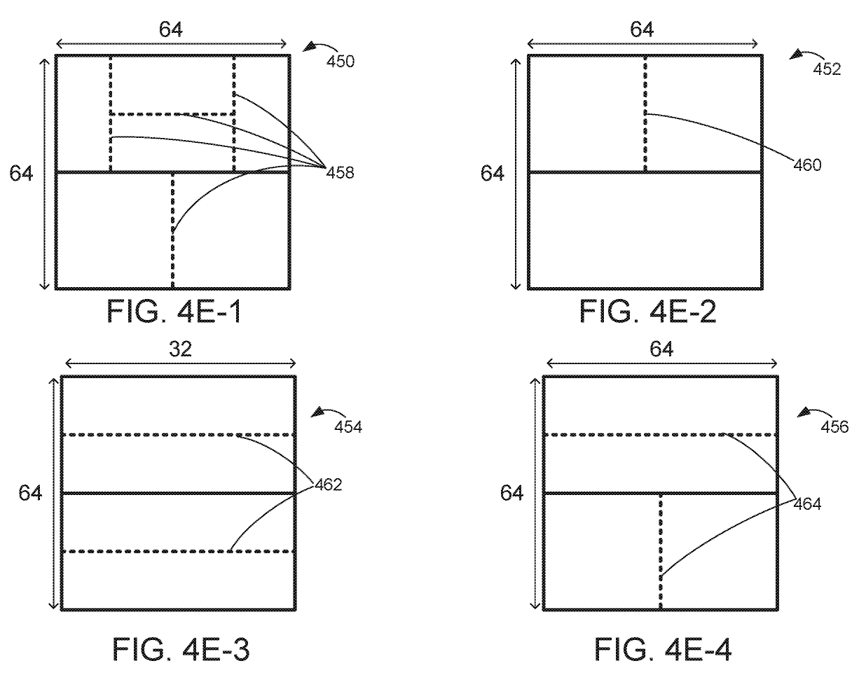

FIG. 4A shows various partition types and partitioning structures in accordance with some embodiments. The root block may start at a predefined level (e.g., from a base block at 128 x 128 or 64 x 64 level). As an example, block 402 is not further partitioned (“PARTITION_NONE”), block 404 is split into two equal horizontal partitions (“PARTITION_HORZ”), and block 406 is split into two equal vertical partitions (“PARTITION_VERT”). Block 408 is an example of a square split where a square is divided into four equal square blocks (“PARTITION_SPLIT”). Blocks 410 and 412 are H-partitions, with the block 410 being split into horizontal H partitions (“PARTITION_HORZ_3”), and the block 412 being split into vertical H partitions (“PARTITION_VERT_3”). The block 410 is horizontally split into three blocks with height ratio 1:2:1. The center block is further vertically split into two equally sized blocks. The block 412 is vertically split into three blocks with width ratio of 1:2:1. The center block is further horizontally split into two equally sized blocks.

FIG. 4A also shows partition types that include partitions from an uneven 4-way split/partitioning scheme that may be implemented horizontally, as shown in blocks 414 (“PARTITION_HORZ_4A”) and 416 (“PARTITION_HORZ_4B”), or vertically, as shown in blocks 418 (“PARTITION_VERT_4A”) and 420 (“PARTITION_HORZ_4B”). In particular, partition 414 is horizontally split into 1:2:4:1 regions. Block 416 is horizontally split into 1:4:2:1 regions. Block 418 is vertically split with 1:2:4:1 regions. Block 420 is vertically split with 1:4:2:1 regions.

As used herein, the phrase “a direction of the partition” may refer to the direction of the split of the first child. For example, the direction of PARTITION_VERT, PARTITION_VERT_3, PARTITION_VERT_4A and PARTITION_VERT_4B is vertical whereas the direction of PARTITION_HORZ, PARTITION_HORZ_3, PARTITION_HORZ_4A and PARTITION_HORZ_4B is horizontal.

As used herein, the phase “semi-decoupled partitioning” (SDP) may refer to a block region in which the luma block and a chroma block share the same partitioning information for the first N levels of the block partitioning and have separate block partitioning (e.g., different block partitions) starting from a partitioning point, called the decoupled partitioning point. The decoupled partitioning point may be implicitly determined based on the partitioning information of the luma block. FIG. 4B shows an example of semi-decoupled partitioning in accordance with some embodiments. The left side of FIG. 4B shows a coding tree structure for a luma component (e.g., a luma block 422) and the right side of FIG. 4B shows a coding tree structure for a chroma component (e.g., a chroma block 424). The numerical values within each block or subblock of the luma block 422 and the chroma block 424 in FIG. 4B indicate the depth of the block partitioning. As is shown, both the luma block 422 and the chroma block 424 share the quad-tree split (e.g., PARTITION_SPLIT, corresponding to the numeral “1”) at the beginning of the super block/coding tree structure. At a depth of 2, a lower left block of the chroma block 424 undergoes another quad-tree split, while an upper right block of the chroma block 424 undergoes a horizontal split (e.g., PARTITION_HORZ). In contrast, a lower left block of the luma block 422 undergoes a vertical split (e.g., PARTITION_VERT), while an upper right block of the luma block 422 undergoes another quad-tree split. The luma block 422 includes another partition at a depth of 4, where the lower left block of the quad-tree split from the depth of 2 is partitioned by yet another quad-tree split at a depth of 3. As a result, the coding tree structure of the luma block and the coding tree structure of the chroma block in FIG. 4B start to have separate block partitioning from that point or from block partitioning depth 1. In some approaches, SDP is applied to key frames and intra region in inter frames. With SDP, a luma block and a chroma block may have different block partitioning starting from 64×64.

A chroma tree may be allowed to choose whether to inherit the block partition from the luma tree or to decouple into a separate tree, depending on the luma block partitioning information. Specifically, a block size threshold T is defined. The threshold is compared to block size of the leaf node in a given luma tree to decide whether the chroma tree would decouple or not. This process may involve investigating multiple block partition depths. Here, the number of partition depths can vary for different luma trees.

SDP may be applied to key frames and intra region in inter frames. With SDP in intra frames, luma and chroma blocks may share the same block partitioning from 128×128 to 64×64 and have different block partitioning starting from 64×64. At the 64×64 partitioning point, the chroma block may inherit the luma block partitions based on luma block partition types. Under the 64×64 partition point, luma blocks and chroma blocks employ separate partitions. Moreover, whether chroma tree can be decoupled or not at the 64×64 decoupling point may depend on the leaf nodes of the collocated luma partition. The recursive search for leaf nodes of the luma block partitions can be challenging for hardware implementation. In some approaches, when the width and height of at least one leaf node of each child partition in the luma block partition (resulting from a block split at 64×64) is less than 32, then the chroma block would inherit the luma partition. Otherwise, the chroma block has a separate partitioning at the 64×64 decoupling point. FIGS. 4C and 4D show examples of chroma decoupling logic.

In FIG. 4C, the bold black lines indicate the first block split at 64×64 in a luma block 426 (e.g., PARTITION_HORZ). Dotted lines 430 indicate child partitions for the luma block 426. Shaded blocks 432, 434, and 436 are leaf nodes. Other (e.g., unshaded) blocks may divide further. In FIG. 4C, the lower child partition (formed from the block split of the luma block 426 at 64×64) that forms the blocks 434 and 436 do not include any leaf nodes with both width and height less than 32. As a result, the chroma block will be decoupled for the partitioning illustrated in FIG. 4C.

In FIG. 4D, the bold black lines indicate the first block split at 64×64 in a luma block 428 (e.g., PARTITION_HORZ). Dotted lines 442 indicate child partitions for the luma block 428. Shaded blocks 438, and 440 are leaf nodes. Other (e.g., unshaded) blocks may divide further. In FIG. 4D, blocks 438 and 440 are leaf nodes with both width and height less than 32. As a result, the chroma block is not decoupled, but inherits the partitioning from the luma block 428 for the partitioning illustrated in FIG. 4D. In some scenarios, the approach illustrated in FIGS. 4C and 4D may result in the search of all leaf nodes in all child partitions. The occurrence of such a recursive search for leaf nodes may be challenging for hardware implementation.

In the systems and methods described herein, the logic at the 64×64 decoupling point in intra frames may be simplified using a partition-direction based approach. The luma partition types for up to 2 levels from the 64×64 point (e.g., chroma decoupling point) is checked (e.g., a maximum depth for checking child luma partitions may be limited to two partition depths from the 64×64 block level), and the partition-direction based approach does not depend on the leaf nodes in the luma partitions. In some embodiments, when the luma block at the 64×64 block level undergoes an uneven-4-way split, the chroma block will be decoupled. In some embodiments, in accordance with a determination that the luma block undergoes an uneven-4-way split at the 64×64 block level, the system decouples the partitioning of the chroma block from the luma block.

When the luma block undergoes block partitioning at 64×64, if all the corresponding child partitions split in the opposite direction, the chroma block inherits the block partitioning from the luma block. Otherwise, the partitioning of the chroma block is decoupled from the partitioning of the luma block. In some embodiments, in accordance with a determination that all corresponding child partitions of the luma block partitioning at 64×64 split in the opposite direction, the system uses the block partitioning of the luma block for the block partitioning of the chroma block. In some embodiments, in accordance with a determination that not all corresponding child partitions of the luma block partitioning at 64×64 split in the opposite direction, the system decouples the partitioning of the chroma block from the partitioning of the luma block.

FIGS. 4E-1-4E-4 illustrate example applications of chroma decoupling logic described herein. In FIG. 4E-1, the bold black lines indicate the first block split at 64×64 in a luma block 450 into two equal horizontal child partitions (e.g., PARTITION_HORZ). Dotted lines 458 indicate partitions for the child partitions, each of the divided partition may divide further. In FIG. 4E-1, the upper child partition of 32×64 is split into vertical H partitions (“PARTITION_VERT_3”), similar to block 412 in FIG. 4A, while the lower child partition of 32×64 is split vertically into two equal portions (“PARTITION_VERT”). Thus, the block partition at 64×64 is horizontal, but all corresponding child partitions split in the opposite direction, and the chroma block inherits the block partitioning from the luma block.

In FIG. 4E-2, the bold black lines indicate the first block split at 64×64 in a luma block 452 into two equal horizontal child partitions (e.g., PARTITION_HORZ). A dotted line 460 indicates partitions for the child partitions, each of the divided partition may divide further. In FIG. 4E-2, the upper child partition of 32×64 is split vertically into two equal partitions (“PARTITION_VERT”), while the lower child partition of 32×64 is not split (“PARTITION_NONE”). Thus, not all corresponding child partitions split in the opposite direction from the parent partition at 64×64, which was split horizontally, and the chroma block does not inherit the block partitioning from the luma block in FIG. 4E-2.

In FIG. 4E-3, the bold black lines indicate the first block split at 64×64 in a luma block 454 into two equal horizontal child partitions (e.g., PARTITION_HORZ). Dotted lines 462 indicate partitions for the child partitions, each of the divided partition may divide further. In FIG. 4E-3, both the upper and lower child partitions of 32×64 are split horizontally into two equal partitions (“PARTITION_HORZ”). Thus, not all corresponding child partitions (e.g., none of the child partitions) split in the opposite direction from the parent partition at 64×64, which was split horizontally, and the chroma block does not inherit the block partitioning from the luma block in FIG. 4E-3.

In FIG. 4E-4, the bold black lines indicate the first block split at 64×64 in a luma block 456 into two equal horizontal child partitions (e.g., PARTITION_HORZ). Dotted lines 464 indicate partitions for the child partitions, each of the divided partition may divide further. In FIG. 4E-4, the upper child partition of 32×64 is split horizontally into two equal partitions (“PARTITION_HORZ”), while the lower child partition of 32×64 is split vertically into two equal partitions (“PARTITION_VERT”). Thus, not all corresponding child partitions split in the opposite direction from the parent partition at 64×64, which was split horizontally, and the chroma block does not inherit the block partitioning from the luma block in FIG. 4E-4.

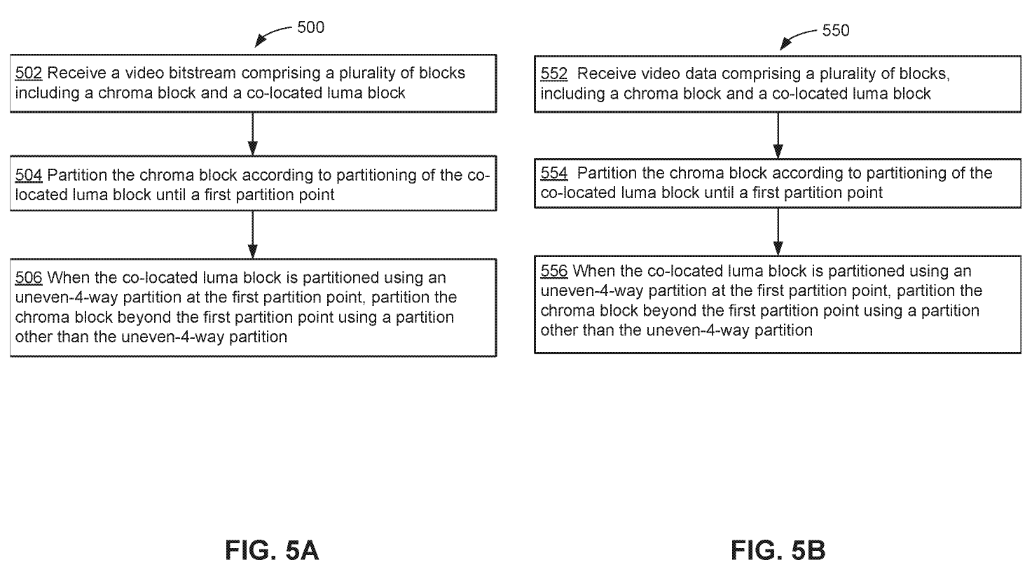

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) video bitstream (e.g., a coded video sequence) comprising a plurality of blocks (e.g., corresponding to a set of pictures) including a chroma block and a co-located luma block. The system partitions (504) the chroma block according to partitioning of the co-located luma block until a first partition point. When the co-located luma block is partitioned using an uneven-4-way partition at the first partition point, the system partitions (506) the chroma block beyond the first partition point using a partition other than the uneven-4-way partition. In this way, when the luma splits into uneven-4-way partitions at decoupling partition point T1, chroma tree is decoupled. In one example T1 is set to block size 64×64.

In some embodiments, the determination of whether chroma partitions would be decoupled from luma partitions or not may depend on the luma block partition types at a decoupling partition point and/or partition types of its child partition nodes at n levels below the decoupling partition point.

In some embodiments, when the luma block splits into uneven-4-way partitions at a decoupling partition point T1, chroma tree is decoupled. In some embodiments, T1 is set to a block size of 64×64. In some embodiments, when the luma block splits into binary partitions at the decoupling partition point T1, the chroma tree is not decoupled. In some embodiments, T1 is set to block size 64×64.

In some embodiments, whether decoupled partitions for a chroma tree are allowed may depend on a direction of the luma block partition types. In some embodiments, whether decoupled partitions for a chroma tree are allowed may depend on a direction of the luma partition at the decoupling partition point and the luma partitions of the children nodes at n levels below the decoupling partition point. In some embodiments, when the luma partition at the decoupling partition point and at least i number of children at n levels below the decoupling partition point T1 do not split, then the chroma tree is decoupled. In some embodiments, n and i are set to 1 and T1 is set to a block size of 64×64. For example, similar to the luma block 452 of FIG. 4E-2.

In some embodiments, whether decoupled partitions for a chroma tree are allowed may depend on the direction of the luma partition at the decoupling partition point and the direction of the luma partitions of the children nodes at n levels below the decoupling partition point. In some embodiments, whether decoupled partitions for a chroma tree are allowed may depend on whether the direction of the luma partition at the decoupling partition point and the direction of the luma partitions of the children nodes at n levels below the decoupling partition point are the same or not.

In some embodiments, when the luma partition at the decoupling partition point and at least i number of children at n levels below the decoupling partition point T1 split in the same direction, the chroma tree is decoupled. In some embodiments, n and i are set to 1 and T1 is set to a block size of 64×64. For example, in the luma block 454 of FIG. 4E-3, both child partitions are split in the same direction, while in the luma block 456 of FIG. 4E-4, only one child partition (e.g., the upper child partition) is split in the same direction.

In some embodiments, when the luma partition at the decoupling partition point and all the children at n levels below the decoupling partition point T1 split in opposite directions, the chroma tree is not decoupled. In some embodiments, n is to 1 and T1 is set to block size 64×64. For example, in the luma block 450 of FIG. 4E-1, both child partitions are split in the opposite direction, and the chroma partitioning is not decoupled from the luma partitioning of the luma block 450.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a plurality of blocks (e.g., corresponding to a set of pictures) including a chroma block and a co-located luma block. The system partitions (554) the current block according to partitioning of the co-located luma block until a first partition point. When the co-located luma block is partitioned using an uneven-4-way partition at the first partition point, the system partitions (556) the chroma block beyond the first partition point using a partition other than the uneven-4-way partition. As described previously, the encoding process may mirror the decoding processes described herein (e.g., block partitioning). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

### Turning now to some example embodiments.

Simulation data on AVM v9 anchor for all-intra and random access configurations has shown that using a simplified logic for SDP at the decoupling point results in 1% encoding time saving and 0.01% coding gain for All Intra mode; 1% decoding time saving and 1% encoding time saving and 0.01% coding gain for Random Access mode; and 1% encoding time saving and 2% decoding time saving with no coding loss for Low Delay mode. Simulation data on AVM v10 anchor for all-intra, random access, and low delay configurations shows a 1% encoding time increase, no decoding time saving, and 0.02% coding gain for All Intra mode; no encoding time increase, no decoding time increase and no coding gain for Random Access mode; and 3% encoding time saving and 1% decoding time increase, and 0.07% coding gain for Low Delay mode.

(A1) In one aspect, some embodiments include a method (e.g., the method 500) of video decoding. In some embodiments, the method is performed at a computing system (e.g., the server system 112) having memory and one or more processors. In some embodiments, the method is performed at a coding module (e.g., the coding module 320). The method includes: (i) receiving a video bitstream comprising a plurality of blocks including a chroma block and a co-located luma block; (ii) partitioning the chroma block according to the partitioning of the co-located luma block until a first partition point; and (iii) when the co-located luma block is partitioned using an uneven-4-way partition at the first partition point, partitioning the chroma block beyond the first partition point using a partition other than the uneven-4-way partition. In this way, when the luma splits into uneven-4-way partitions at decoupling partition point T1, chroma tree is decoupled. In one example T1 is set to block size 64×64.

(A2) In some embodiments of A1, when the co-located luma block is partitioned using a partition other than the uneven-4-way partition at the first partition point, the chroma block beyond the first partition point is partitioned using the same partition as the co-located luma block. For example, if the luma block is split horizontally or vertically into two equal partitions (such as PARTITION_HORZ or PARTITION_VERT), the chroma block will inherit this partitioning, maintaining alignment and reducing complexity.

(A3) In some embodiments of A1 or A2, the method further comprises determining whether partitioning of the chroma block beyond the first partition point is the same as partitioning for the co-located luma block based on the directionality of child partitions of the co-located luma block. For example, the system may examine whether the child partitions immediately below the 64×64 split are all split in the same direction or in different directions.

(A4) In some embodiments of A3, determining whether partitioning of the chroma block beyond the first partition point is the same as partitioning for the co-located luma block based on directionality of the child partitions of the co-located luma block comprises: when the co-located luma block is partitioned at the first partition point such that child partitions of the co-located luma block have the same direction, partitioning the chroma block beyond the first partition point using different partitioning than the co-located luma block. For example, allowing decoupled partitions for chroma tree may depend on the direction of the luma partition at the decoupling partition point and the direction of the luma partitions of the children nodes at n levels below the decoupling partition point.

(A5) In some embodiments of A3 or A4, determining whether partitioning of the chroma block beyond the first partition point is the same as partitioning for the co-located luma block based on directionality of the child partitions of the co-located luma block comprises: when the co-located luma block is partitioned at the first partition point such that child partitions of the co-located luma block have different directions, partitioning the chroma block beyond the first partition point using the same partitioning as the co-located luma block. For example, if one child partition is split vertically and the other horizontally, the chroma block may inherit the luma partitioning. For example, allowing decoupled partitions for chroma tree may depend on whether the direction of the luma partition at the decoupling partition point and luma partitions of the children nodes at n levels below the decoupling partition point is same or not.

(A6) In some embodiments of any of A3-A5, determining whether partitioning of the chroma block beyond the first partition point is the same as partitioning for the co-located luma block based on directionality of the child partitions of the co-located luma block comprises determining whether all child partitions of the co-located luma block have different directionalities. For example, if each child partition uses a different split direction, the chroma block may inherit the luma partitioning.

(A7) In some embodiments of any of A1-A6, the first partition point corresponds to a block size of 64 samples by 64 samples, which is a common decoupling point in semi-decoupled partitioning schemes.

(B1) In another aspect, some embodiments include a method (e.g., the method 550) of video encoding. In some embodiments, the method is performed at a computing system (e.g., the server system 112) having memory and one or more processors. In some embodiments, the method is performed at a coding module (e.g., the coding module 320). The method includes: (i) receiving video data comprising a plurality of blocks, including a chroma block and a co-located luma block; (ii) partitioning the chroma block according to partitioning of the co-located luma block until a first partition point; and (iii) when the co-located luma block is partitioned using an uneven-4-way partition at the first partition point, partitioning the chroma block beyond the first partition point using a partition other than the uneven-4-way partition. For example, in encoding, if the luma block at the 64×64 partition point is split into uneven-4-way partitions, the chroma block is decoupled and encoded using a different partitioning scheme.

(B2) In some embodiments of B1, the method further comprises signaling encoded information for the chroma block according to the partitioning of the chroma block.

(B3) In some embodiments of B1 or B2, when the co-located luma block is partitioned using a partition other than the uneven-4-way partition at the first partition point, the chroma block beyond the first partition point is partitioned using the same partition as the co-located luma block. For example, if the luma block is split using PARTITION_HORZ, the chroma block will also be split horizontally.

(B4) In some embodiments of any of B1-B3, the first partition point corresponds to a block size of 64 samples by 64 samples, which is a standard decoupling point in the described semi-decoupled partitioning logic.

(B5) In some embodiments of any of B1-B4, the method further comprises determining whether partitioning of the chroma block beyond the first partition point is the same as partitioning for the co-located luma block based on directionality of child partitions of the co-located luma block. For example, the encoder may analyze the direction of splits in the child partitions to decide whether to decouple the chroma partitioning.

(B6) In some embodiments of B5, determining whether partitioning of the chroma block beyond the first partition point is the same as partitioning for the co-located luma block based on directionality of the child partitions of the co-located luma block comprises determining whether all child partitions of the co-located luma block have different directionalities. For example, if the child partitions are split in various directions, the chroma block may inherit the luma partitioning.

(B7) In some embodiments of B5 or B6, determining whether partitioning of the chroma block beyond the first partition point is the same as partitioning for the co-located luma block based on directionality of the child partitions of the co-located luma block comprises: when the co-located luma block is partitioned at the first partition point such that child partitions of the co-located luma block have the same direction, partitioning the chroma block beyond the first partition point using different partitioning than the co-located luma block. For example, if both child partitions are split vertically, the chroma block may be decoupled.

(B8) In some embodiments of any of B5-B7, determining whether partitioning of the chroma block beyond the first partition point is the same as partitioning for the co-located luma block based on directionality of the child partitions of the co-located luma block comprises: when the co-located luma block is partitioned at the first partition point such that child partitions of the co-located luma block have different directions, partitioning the chroma block beyond the first partition point using the same partitioning as the co-located luma block.

(C1) In another aspect, some embodiments include a method of visual media data processing. In some embodiments, the method is performed at a computing system (e.g., the server system 112) having memory and one or more processors. In some embodiments, the method is performed at a coding module (e.g., the coding module 320). The method includes: (i) generating a video bitstream, including: (a) partitioning the chroma block according to partitioning of the co-located luma block until a first partition point; and (b) when the co-located luma block is partitioned using an uneven-4-way partition at the first partition point, partitioning the chroma block beyond the first partition point using a partition other than the uneven-4-way partition; and (ii) transmitting the video bitstream including the encoded current block. The video bitstream comprises a plurality of encoded blocks, including encoded information for a chroma block and a co-located luma block.

(C2) In some embodiments of C1, when the co-located luma block is partitioned using a partition other than the uneven-4-way partition at the first partition point, the chroma block is partitioned beyond the first partition point using a same partition as the co-located luma block.

(C3) In some embodiments of C1 or C2, the first partition point corresponds to a block size of 64 samples by 64 samples.

(C4) In some embodiments of any of C1-C3, the video encoding method further comprises determining whether partitioning of the chroma block beyond the first partition point is the same as partitioning for the co-located luma block based on directionality of child partitions of the co-located luma block.

(C5) In some embodiments of C4, determining whether partitioning of the chroma block beyond the first partition point is the same as partitioning for the co-located luma block based on directionality of the child partitions of the co-located luma block comprises determining whether all child partitions of the co-located luma block have different directionalities.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A7, B1-B8, and C1-C5, above). In yet another aspect, some embodiments include a non-transitory computer-readable storage medium storing one or more sets of instructions for execution by control circuitry of a computing system, the one or more sets of instructions including instructions for performing any of the methods described herein (e.g., A1-A7, B1-B8, and C1-C5 above).

Unless otherwise specified, any of the syntax elements described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context. As used herein, N refers to a variable number. Unless explicitly stated, different instances of N may refer to the same number (e.g., the same integer value, such as the number 2) or different numbers.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks including a chroma block and a co-located luma block;
partitioning the chroma block according to partitioning of the co-located luma block until a first partition point; and
when the co-located luma block is partitioned using an uneven-4-way partition at the first partition point, partitioning the chroma block beyond the first partition point using a partition other than the uneven-4-way partition.

2. The method of claim 1, further comprising, when the co-located luma block is partitioned using a partition other than the uneven-4-way partition at the first partition point, partitioning the chroma block beyond the first partition point using a same partition as the co-located luma block.

3. The method of claim 1, further comprising determining whether partitioning of the chroma block beyond the first partition point is the same as partitioning for the co-located luma block based on directionality of child partitions of the co-located luma block.

4. The method of claim 3, wherein determining whether partitioning of the chroma block beyond the first partition point is the same as partitioning for the co-located luma block based on directionality of the child partitions of the co-located luma block comprises:
when the co-located luma block is partitioned at the first partition point such that child partitions of the co-located luma block have the same direction, partitioning the chroma block beyond the first partition point using different partitioning than the co-located luma block.

5. The method of claim 3, wherein determining whether partitioning of the chroma block beyond the first partition point is the same as partitioning for the co-located luma block based on directionality of the child partitions of the co-located luma block comprises:
when the co-located luma block is partitioned at the first partition point such that child partitions of the co-located luma block have different directions, partitioning the chroma block beyond the first partition point using the same partitioning as the co-located luma block.

6. The method of claim 3, wherein determining whether partitioning of the chroma block beyond the first partition point is the same as partitioning for the co-located luma block based on directionality of the child partitions of the co-located luma block comprises determining whether all child partitions of the co-located luma block have different directionalities.

7. The method of claim 1, wherein the first partition point corresponds to a block size of 64 samples by 64 samples.

8. A method of video encoding performed at a computing system having memory and one or more processors, the method comprising:
receiving video data comprising a plurality of blocks, including a chroma block and a co-located luma block;
partitioning the chroma block according to partitioning of the co-located luma block until a first partition point; and
when the co-located luma block is partitioned using an uneven-4-way partition at the first partition point, partitioning the chroma block beyond the first partition point using a partition other than the uneven-4-way partition.

9. The method of claim 8, further comprising signaling encoded information for the chroma block accordingly to partitioning of the chroma block.

10. The method of claim 8, further comprising, when the co-located luma block is partitioned using a partition other than the uneven-4-way partition at the first partition point, partitioning the chroma block beyond the first partition point using a same partition as the co-located luma block.

11. The method of claim 8, wherein the first partition point corresponds to a block size of 64 samples by 64 samples.

12. The method of claim 8, further comprising determining whether partitioning of the chroma block beyond the first partition point is the same as partitioning for the co-located luma block based on directionality of child partitions of the co-located luma block.

13. The method of claim 12, wherein determining whether partitioning of the chroma block beyond the first partition point is the same as partitioning for the co-located luma block based on directionality of the child partitions of the co-located luma block comprises determining whether all child partitions of the co-located luma block have different directionalities.

14. The method of claim 12, wherein determining whether partitioning of the chroma block beyond the first partition point is the same as partitioning for the co-located luma block based on directionality of the child partitions of the co-located luma block comprises:
when the co-located luma block is partitioned at the first partition point such that child partitions of the co-located luma block have the same direction, partitioning the chroma block beyond the first partition point using different partitioning than the co-located luma block.

15. The method of claim 12, wherein determining whether partitioning of the chroma block beyond the first partition point is the same as partitioning for the co-located luma block based on directionality of the child partitions of the co-located luma block comprises:
when the co-located luma block is partitioned at the first partition point such that child partitions of the co-located luma block have different directions, partitioning the chroma block beyond the first partition point using the same partitioning as the co-located luma block.

16. A non-transitory computer-readable storage medium storing a video bitstream that is generated by a video encoding method, the video bitstream comprising:
a plurality of encoded blocks, including encoded information for a chroma block and a co-located luma block; and
wherein the video encoding method comprises:
partitioning the chroma block according to partitioning of the co-located luma block until a first partition point; and
when the co-located luma block is partitioned using an uneven-4-way partition at the first partition point, partitioning the chroma block beyond the first partition point using a partition other than the uneven-4-way partition.

17. The non-transitory computer-readable storage medium of claim 16, wherein, when the co-located luma block is partitioned using a partition other than the uneven-4-way partition at the first partition point, the chroma block is partitioned beyond the first partition point using a same partition as the co-located luma block.

18. The non-transitory computer-readable storage medium of claim 16, wherein the first partition point corresponds to a block size of 64 samples by 64 samples.

19. The non-transitory computer-readable storage medium of claim 16, wherein the video encoding method further comprises determining whether partitioning of the chroma block beyond the first partition point is the same as partitioning for the co-located luma block based on directionality of child partitions of the co-located luma block.

20. The non-transitory computer-readable storage medium of claim 19, wherein determining whether partitioning of the chroma block beyond the first partition point is the same as partitioning for the co-located luma block based on directionality of the child partitions of the co-located luma block comprises determining whether all child partitions of the co-located luma block have different directionalities.
